(19) United States
(12) Patent Application Publication
(10) Pub. No.: US 2018/0126770 A1
(43) Pub. Date: May 10, 2018

(54) SUPPORT ON WHICH DATA WHICH IS TO BE KEPT SECRET CAN BE APPLIED AND DATA SUPPORT WITH APPLIED DATA WHICH IS TO BE KEPT SECRET

(71) Applicant: KSG - KAPPELMAIER SERVICE GMBH, TRAUNSTEIN (DE)

(72) Inventors: MICHAEL KAPPELMAIER, TRAUNSTEIN (DE); KATRIN KAPPELMAIER, TRAUNSTEIN (DE); FELIX KAPPELMAIER, NUSSDORF (DE)

(21) Appl. No.: 15/575,553

(22) PCT Filed: May 18, 2016
(86) PCT No.: PCT/EP2016/061167

§ 371 Date: Nov. 20, 2017

(30) Foreign Application Priority Data
May 19, 2015 (DE) 10 2015 006 334.0

(51) Int. Cl. B42D 25/378; B42D 25/387; B42D 25/45; B42D 25/342; B42D 25/41; B41M 3/14; B41M 1/10; B41M 1/04; B41M 1/12

(52) U.S. Cl. CPC B42D 25/378; B42D 25/387; B42D 25/45; B42D 25/342; B41M 1/12; B41M 3/142; B41M 1/10; B41M 1/04; B42D 25/41

(57) ABSTRACT

A carrier for applying confidential data includes a substrate and a background applied to the substrate, in particular a concealment background, including an irregular configuration of characters. The characters are formed of a transparent non-chromogenic printing ink which phosphoresces under UV light. A data carrier having applied confidential data is also provided.

The present invention relates to a carrier for applying confidential data. Moreover, the invention relates to a data carrier having applied confidential data.

In order to communicate confidential data, such as TAN numbers for online banking, PIN numbers for activating check cards or credit cards, PUK numbers for mobile communications applications, access codes or the like, a special data carrier is usually forwarded from a sender to a recipient, which data carrier is intended to rule out that a person different from the recipient gains a knowledge of the confidential data.

In this regard, DE 197 47 818 A1 has disclosed a document for communicating secret information, which document consists of a paper sheet and a carbon copy set which are connected fixedly to one another, a mechanical printer, by way of which secret information is written into the carbon copy set, and a non-mechanical printer, by way of which the paper sheet is printed, being used to print the document. This solution is comparatively complicated, however, in terms of printing technology and with regard to the construction of the document.

Furthermore, data carriers are known, in which confidential data is covered by way of a scratch coating, and the data is made visible by the recipient by way of the scratch coating being scratched off, as described, for example, in DE 101 50 136 A1 and DE 197 33 876 A1. In order to produce said data carriers, a paper substrate is printed, for example by way of a laser printer, with confidential data, and the printed region is subsequently provided with a clear varnish and then with the scratch varnish layer. Complete security of the confidential data is not ensured in the case of said data carriers, since the information which is printed on initially remains visible immediately after being printed on, until it is hidden by way of the following coating steps. In addition, the coating operation is comparatively complicated in the case of said technology.

U.S. Pat. No. 4,109,047 A has disclosed a multiple-layer data carrier, in which the confidential data is formed by a transparent chromogenic printing ink, and is initially not visible, but becomes permanently visible as a consequence of a pressure treatment of the carrier.

US 2001/0 020 785 A1 discloses a data carrier, in which the confidential data is formed by a non-thermochromic dark ink and is applied on a dark concealment background which is printed using a thermochromic ink. Said data becomes readable when heat acts on the thermochromic ink of the concealment background, and thus the optical properties thereof are changed. Said thermochromic read protection proves to be disadvantageous in the case of all heat fixing printing techniques, such as in the case of classic laser printing. The prior art accordingly precludes application of the confidential data with a heat fixing laser printer if unauthorized manipulation is to be clearly detectable. However, precisely this type of laser printer is the standard everywhere nowadays. Cold fixing laser printers are as a rule used only for very specific applications, since their operation is uneconomical for most applications, in contrast to heat fixing systems.

WO 2009/103 021 A1 and EP 2 301 761 A1 discloses data carriers having a structural or underlying print and a transparent carrier, on which the confidential data is applied. The carrier and the structural or underlying print have to be separated, in order for it to be possible for the applied information to be read. Here, a chromogenic ink layer serves as a security feature, in order for it to be possible to detect if unauthorized persons should attempt to make the applied confidential data visible, for example by way of heat or solvent.

The present invention is concerned with the problem of providing a carrier for applying confidential data and a data carrier having applied confidential data, which can be produced simply, and by way of which the greatest possible security of the confidential data is ensured. In addition, the application of the confidential data is to be possible by way of common printing methods, in particular by way of heat fixing printing methods, in particular by way of standard laser printers.

According to the invention, said problem is solved by way of the subjects of the independent claims. Advantageous embodiments are the subject matter of the dependent claims.

The present invention is based on the general concept of making confidential data visible on a substrate or carrier by way of irreversible changing of a heat-resistant hydrochromic and/or piezochromic printing ink, from which either the confidential data is formed, or which is situated on the carrier together with the confidential data.

This has the advantage that, firstly, the production of the carrier or the data carrier is comparatively simple, since merely one printing operation or a plurality of printing operations are required, and, secondly, reading of the confidential data by unauthorized third parties is not possible without leaving traces.

Preferred exemplary embodiments of the invention are shown in the drawings and will be described in greater detail in the following description, identical designations relating to identical or similar or functionally identical features.

In the drawings, in each case diagrammatically:

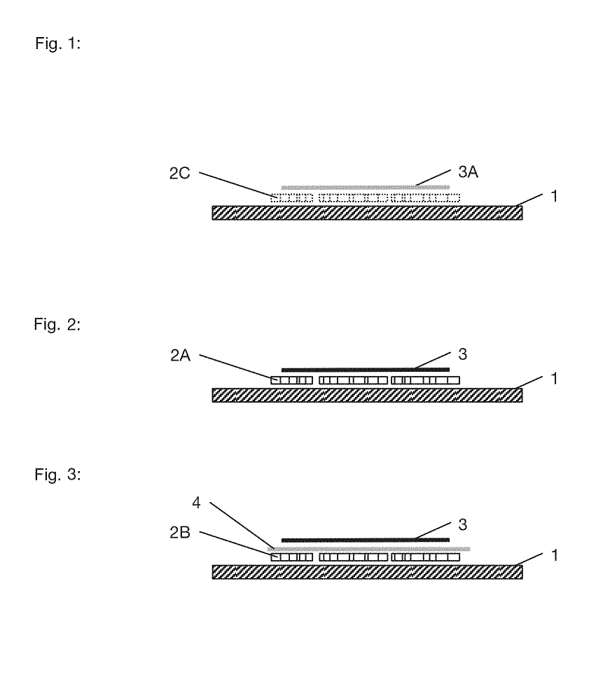

FIG. 1 shows a cross-sectional illustration of a data carrier in accordance with the second embodiment of the present invention,

FIG. 2 shows a cross-sectional illustration of a data carrier in accordance with the fourth embodiment of the present invention,

FIG. 3 shows a cross-sectional illustration of a data carrier in accordance with the sixth embodiment of the present invention,

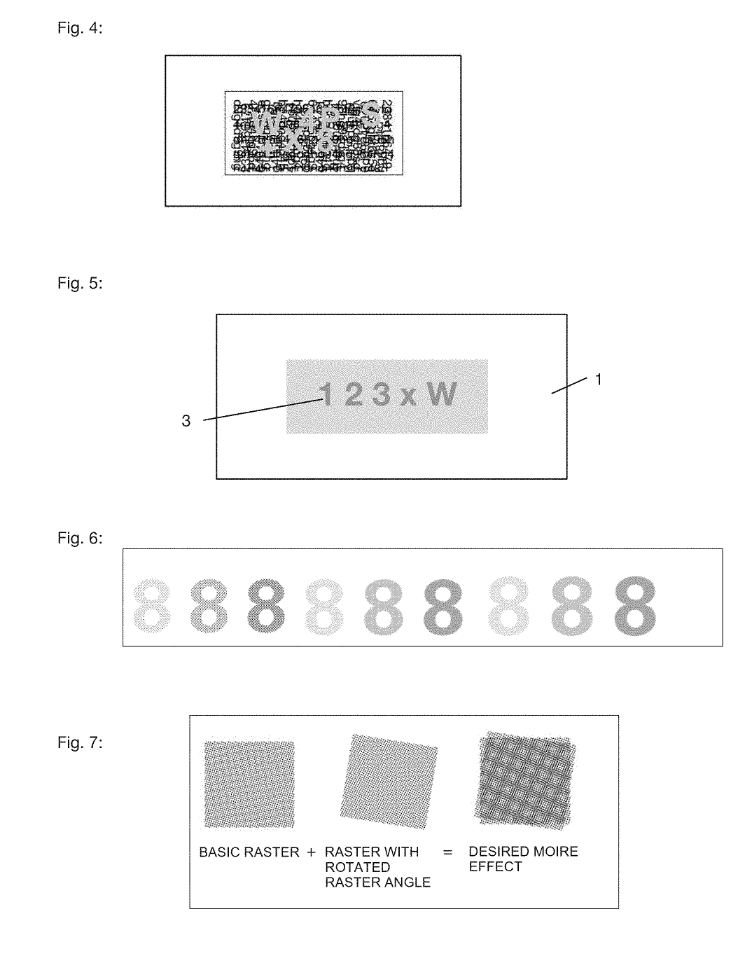

FIG. 4 shows a plan view of a background of a carrier in accordance with the first, third and the fifth embodiment, the concealment background actually being transparent in the case of the first embodiment,

FIG. 5 shows a plan view of confidential data of a data carrier in accordance with the second, the fourth and the sixth embodiment, after a physical and/or chemical action has been carried out on the data carrier,

FIG. 6 shows examples for different raster thicknesses and raster widths of the characters which are used both in the concealment background and during the application of the confidential data, and

FIG. 7 shows a diagrammatic illustration in order to explain the desired moiré effect which additionally makes an unauthorized identification of the confidential data more difficult or virtually impossible.

In a first embodiment, the present invention relates to a carrier for applying confidential data comprising: a substrate (1) and a concealment background (2C) which is applied on the substrate (1) and comprises a non-chromogenic transparent printing ink which begins to phosphoresce under UV light.

In a second embodiment which is shown in FIG. 1, the present invention relates to a data carrier having applied confidential data (3A), comprising: a carrier of the above-described first embodiment, and confidential data (3A) which is applied on the background (2C) of the carrier, the confidential data (3A) being formed from a heat-resistant hydrochromic and/or piezochromic printing ink which is transparent before an external physical and/or chemical action, or the coloration of which is identical to the coloration of the substrate (1) before an external physical and/or chemical action and is irreversibly non-transparent after the external physical and/or chemical action, or is irreversibly different than the coloration of the substrate (1) after the external physical and/or chemical action.

Any flat structure at all which can be printed using printing inks can expediently be used as a substrate (1). In particular, paper or polymer films (polyethylene, polypropylene and the like, optionally colored in a suitable way), preferably paper with a commercially available weight per unit area, are used as the substrate (1). For example, an offset paper having a weight per unit area of from 70 to 90 g/m², in particular 80 g/m², can be used as the paper.

The confidential data (3A) which is shown by way of example in FIG. 5 is formed from a heat-resistant hydrochromic and/or piezochromic printing ink which, in the case of an external physical and/or chemical action, either changes irreversibly from a transparent into a non-transparent state or irreversibly changes its coloration.

An external physical and/or chemical action is understood to mean an action by way of moisture and/or pressure.

Here, the corresponding heat-resistant hydrochromic and/or piezochromic printing inks are called hydrochromic, piezochromic or piezochromic/hydrochromic printing inks.

Suitable heat-resistant hydrochromic and/or piezochromic printing inks or heat-resistant hydrochromic and/or piezochromic constituent parts for heat-resistant hydrochromic and/or piezochromic printing inks are known to a person skilled in the art.

Here, in particular, piezochromic printing inks can be present not only as homogeneous liquids, but rather can be dispersions of liquid-filled, for example water-filled, microspheres in a matrix liquid. Here, the liquid in the microspheres can be released in the case of an action of pressure on the applied cured printing ink, and can enter into a chemical and/or physical reaction with the constituent parts of the matrix. Here, said reaction can bring about either a discolorization or a color change of the matrix.

For example, irreversible photochromic and thermochromic printing inks or constituent parts for chromogenic printing inks can be obtained from the company Skyrad Ltd., Nesher, Israel, and the company LCR Hallcrest Ltd., Flintshire, Great Britain.

For example, “UV Fluorescent Inks” from the company Luminescence, Essex, Great Britain can be used for the concealment background comprising a transparent printing ink which begins to phosphoresce under UV light.

In the case of the above-described data carrier having applied confidential data (3A) of the second embodiment, the confidential data (3A) is either transparent or it has the same coloration as the substrate (1), with the result that the confidential data (3A) cannot be identified on the substrate (1). If, however, a physical and/or chemical action is carried out on the heat-resistant hydrochromic and/or piezochromic printing ink of the confidential data (3A), such as by way of the exertion of pressure on the data carrier by way of rubbing with the edge of a coin or the like, the heat-resistant hydrochromic and/or piezochromic printing ink of the confidential data (3A) either becomes irreversibly non-transparent or the coloration of the heat-resistant hydrochromic and/or piezochromic printing ink of the confidential data (3A) changes and becomes irreversibly different than the coloration of the substrate 1. As a result, the confidential data (3A) which is printed on the substrate (1) becomes irreversibly visible. Undetected identification of the confidential data (3A) by way of third parties is prevented reliably here by way of the irreversibility of said operation.

In conjunction with all the embodiments of said invention, a heat-resistant hydrochromic and/or piezochromic printing ink is understood to mean a hydrochromic and/or piezochromic printing ink which can be loaded thermally at least up to a maximum temperature limit of 250° C. without losing its technical properties. This is absolutely necessary, in particular, for heat fixing printing methods, such as standard laser printing methods.

In a third embodiment, the present invention relates to a carrier for applying confidential data (3), comprising: a substrate (1) and a background (2A) which is applied on the substrate (1) and comprises an irregular arrangement of characters, the characters being formed from a heat-resistant hydrochromic and/or piezochromic printing ink which irreversibly changes its coloration in the case of an external physical and/or chemical action.

With regard to the substrate and the heat-resistant hydrochromic and/or piezochromic printing ink of the carrier of the second embodiment, reference is made to the corresponding comments in respect of the substrates and the heat-resistant hydrochromic and/or piezochromic printing inks of the data carrier of the first embodiment.

The irregular arrangement of characters of the background (2A) which is shown by way of example in FIG. 4 can be any desired characters, such as numbers, letters or other characters with any desired shape. The characters of the background (2A) are applied in a number and density such that confidential data (3) which are printed on the background (2A) in the same coloration as the latter can be identified neither when viewing the surface nor if it is potentially possible to look through the data carrier. A background or underlying print of this type is also called a concealment background, and, in addition to figures, numerals and other characters, preferably also consists in locations of rastered elements. The expedient implementation of a concealment background of this type is known to a person skilled in the relevant art and will therefore not be described in greater detail here. The adaptation of the rastered elements of the concealment background in relation to raster thickness, raster width and raster angle to the raster thickness, raster width and raster angle of the confidential data, in order to achieve the desired moiré effect, can be performed by a person skilled in the relevant art.

FIG. 7 shows a diagrammatic illustration which graphically describes the desired moiré effect which is described as preferred according to the invention.

In a fourth embodiment which is shown in FIG. 2, the present invention relates to a data carrier having applied confidential data (3), comprising: a carrier of the above-described third embodiment, and confidential data (3) which is applied on the background (2A) of the carrier, the confidential data (3) being formed from a non-chromogenic printing ink, the coloration of which is identical to the coloration of the concealment background before an external physical and/or chemical action, and is different than the coloration of the concealment background (2A) after the external physical and/or chemical action.

Here, for example, any toner at all of laser printers or any ink at all of inkjet printers with the suitable coloration can be used as the non-chromogenic printing ink for the confidential data (3) which is shown by way of example in FIG. 5.

In the case of the above-described data carrier having applied confidential data (3) of the fourth embodiment, the confidential data (3) have the same coloration as the heat-resistant hydrochromic and/or piezochromic printing ink of the characters of the background (2A), with the result that the confidential data (3) cannot be identified. If, however, a physical and/or chemical action is carried out on the heat-resistant hydrochromic and/or piezochromic printing ink of the characters of the background (2A), such as, for example, by way of the exertion of pressure on the data carrier from the uncoated substrate side by way of friction using an edge of a coin or the like, the coloration of the heat-resistant hydrochromic and/or piezochromic printing ink of the characters of the background (2A) changes and becomes irreversibly different than the coloration of the confidential data (3). As a result, the confidential data (3) which is printed on the background (2A) becomes irreversibly visible. Here, an undetected identification of the confidential data (3) by third parties is prevented reliably by way of the irreversibility of said operation.

In a fifth embodiment, the present invention relates to a carrier for applying confidential data (3), comprising: a substrate (1), a background (2B) which is applied on the substrate (1) and comprises a concealment background, for example an irregular arrangement of characters, the characters being formed from a non-chromogenic printing ink, and a layer (4) which is applied on the concealment background (2B) and comprises a transparent heat-resistant hydrochromic and/or piezochromic printing ink which becomes irreversibly non-transparent in the case of an external physical and/or chemical action.

The carrier of the fifth embodiment differs from the carrier of the third embodiment in that the characters of the concealment background (2B) are formed from a non-chromogenic printing ink, and a layer (4) comprising a transparent heat-resistant hydrochromic and/or piezochromic printing ink lies on the concealment background (2B). Only said differences will be described in the following text.

Any desired printing ink which is suitable for the respective printing method and does not change its coloration as a result of an external physical and/or chemical action can be used as the non-chromogenic printing ink. Here, for example, black no. 093110 from the company Jänecke+Schneemann Druckfarben GmbH, Sehnde Höver, Germany can be mentioned as a specific example.

With regard to the substrate and the transparent heat-resistant hydrochromic and/or piezochromic printing ink of the carrier of the fifth embodiment, reference is made to the corresponding statements in respect of the substrates and the heat-resistant hydrochromic and/or piezochromic printing inks of the carrier of the first embodiment. Here, a person skilled in the art is capable of selecting a heat-resistant hydrochromic and/or piezochromic printing ink with a suitable transparency which must be such that the characters of the concealment background (2B) comprising a non-chromogenic printing ink have to be visible through the transparent heat-resistant hydrochromic and/or piezochromic printing ink.

In a sixth embodiment which is shown in FIG. 3, the present invention relates to a data carrier having applied confidential data (3), comprising: a carrier of the above-described fifth embodiment and confidential data (3) which is applied on the layer (4) comprising a transparent heat-resistant hydrochromic and/or piezochromic printing ink, the confidential data (3) being formed from a non-chromogenic printing ink, the coloration of which is identical to the coloration of the concealment background (2B) before an external physical and/or chemical action, and is different from the non-transparent coloration of the layer (4) comprising a transparent heat-resistant hydrochromic and/or piezochromic printing ink after an external physical and/or chemical action.

With regard to the non-chromogenic printing ink for the confidential data (3) in the case of the data carrier in accordance with the sixth embodiment, reference is made to the corresponding embodiments with regard to the data carrier in accordance with the fourth embodiment.

In the case of the above-described data carrier having applied confidential data (3) of the sixth embodiment, the confidential data (3) has the same coloration as the non-chromogenic printing ink of the characters of the concealment background (2B), with the result that the confidential data (3) cannot be identified. If, however, a physical and/or chemical action is carried out on the transparent heat-resistant hydrochromic and/or piezochromic printing ink (layer 4), such as by way of exertion of pressure on the data carrier from the uncoated substrate side by way of friction using an edge of a coin or the like, the transparent heat-resistant hydrochromic and/or piezochromic printing ink becomes non-transparent and irreversibly different than the coloration of the confidential data (3). As a result, the background (2B) can no longer be identified through the non-transparent printing ink, and the confidential data (3) which is printed on the non-transparent printing ink becomes irreversibly visible. Here, an undetected identification of the confidential data (3) by third parties is prevented reliably by way of the irreversibility of said operation.

Customary printing methods, such as offset printing, letterpress printing, gravure printing, flexographic printing or screen printing, can be used to print the substrate (1) for producing a carrier in accordance with one embodiment of the present invention with the heat-resistant hydrochromic and/or piezochromic or non-chromogenic concealment background (2A) or 2B and the layer (4) comprising the transparent heat-resistant hydrochromic and/or piezochromic printing ink. Here, a person skilled in the relevant art is capable of selecting the printing method which is best suitable for the respective substrate and the respective printing ink in a simple way.

According to one preferred embodiment, the layer thickness of the heat-resistant hydrochromic and/or piezochromic or non-chromogenic concealment background (2A) or (2B) and the layer (4) comprising the transparent chromogenic printing ink preferably lie in the range from 0.5 g/m² to 5 g/m², further preferably in the range from 0.8 g/m² to 4 g/m² and, in particular, in the range from 1.0 g/m² to 3 g/m².

According to a further preferred embodiment, the coloration of the heat-resistant hydrochromic and/or piezochromic printing ink of the background before the external physical and/or chemical action or the coloration of the non-chromogenic printing ink of the background is black.

Finally, printing of the substrate or the carrier with the confidential data (3) in order to produce a data carrier according to the invention takes place by way of a customary printing method which is adapted to the character of the heat-resistant hydrochromic and/or piezochromic printing ink. That is to say, the printing method is selected in such a way that no physical and/or chemical action, in particular no pressure and/or no moisture which changes its coloration is effected on the heat-resistant hydrochromic and/or piezochromic printing ink during the execution of the printing method. A corresponding selection is possible in a simple way for a person skilled in the relevant art. Examples for printing methods for printing the substrate or the carrier with the confidential data are, for example, laser printing and inkjet printing.

The present invention is suitable, in particular, for applying the confidential data by way of a heat fixing laser printer, since the heat-resistant hydrochromic and/or piezochromic printing ink according to the invention does not react to heat, but rather to moisture (hydrochromic) or pressure (piezochromic) or to a combination of pressure and moisture.

In one advantageous development of the abovementioned embodiments, not only different numerals, figures and characters, but rather also rastered elements in locations are used as an additional security feature for the underlying print which prevents unauthorized detection of the confidential data. By way of the moiré effect which is produced and is known to a person skilled in the art, said rastered elements more reliably prevent detection of the confidential data which can likewise be printed as rastered numerals, figures or characters. Here, both the background, in particular the concealment background, and the confidential data are formed by a heat-resistant hydrochromic and/or piezochromic printing ink or by a non-chromogenic printing ink, depending on the embodiment.

It goes without saying that the abovementioned features can be used not only in the respectively specified combination, but rather also in other combinations or on their own, without departing from the scope of the present invention.

The following examples serve to further describe the present invention and are not to be considered to be restrictive.

### EXAMPLE 1

A sheet of white offset paper with a weight per unit area of 100 g/m² as a substrate was printed using offset printing with a concealment background comprising a non-chromogenic, transparent printing ink (layer thickness 0.6 g/m², “UV Fluorescent Inks” from the company Luminescence, Essex, Great Britain), and numerals as confidential data were then printed by means of a commercially available inkjet printer with a transparent piezochromic printing ink (layer thickness: 0.9 g/m², Coin Reactive Ink, available from the company Sicpa, Lausanne, Switzerland, coloration: colorless before the action of pressure by way of a coin, black after the action of pressure by way of a coin), with the result that a data carrier according to the invention in accordance with the second embodiment was obtained. The confidential data on the data carrier could not be identified.

A powerful rubbing action was carried out by means of a coin on the obtained data carrier on the printed side of the substrate in that region of the data carrier in which the confidential data is present, as a result of which the printed confidential data became visible.

### EXAMPLE 2

A sheet of white offset paper with a weight per unit area of 80 g/m² as a substrate was printed with a concealment background as background (layer thickness: 0.6 g/m²), with the result that a carrier according to the invention in accordance with the third embodiment was obtained. The printing ink which was used here was an irreversibly piezochromic black printing ink which has a changed coloration after an action of pressure. Numerals as confidential data were then printed onto said background by means of a commercially available laser printer with a black toner, with the result that a data carrier according to the invention in accordance with the fourth embodiment was obtained. The confidential data on the data carrier could not be identified.

The obtained data carrier was placed onto a hard surface, and pressure was exerted with the edge of a coin by way of rubbing, from the uncoated side of the substrate, onto that region of the data carrier on which the confidential data is present, as a result of which the printed confidential data became visible.

### EXAMPLE 3

A sheet of green offset paper with a weight per unit area of 90 g/m² as a substrate was printed with a concealment background (layer thickness: 0.6 g/m²). The printing ink which was used was a non-chromogenic black printing ink (black no. 093110 from the company Jänecke+Schneemann Druckfarben GmbH, Sehnde Höver, Germany). A layer comprising a transparent heat-resistant hydrochromic printing ink (layer thickness: 0.9 g/m²) was then applied onto the background, with the result that a carrier according to the invention in accordance with the fifth embodiment was obtained. Numerals as confidential data were then printed onto said layer by means of a commercially available laser printer with a black toner, with the result that a data carrier according to the invention in accordance with the sixth embodiment was obtained. The confidential data on the data carrier could not be identified.

The obtained data carrier was then moistened with water at the location at which the confidential data was present. The layer which was applied onto the concealment background and comprised hydrochromic printing ink became irreversibly green as a result. The applied confidential data became irreversibly visible as a result.

The present invention is suitable, in particular, for producing a data carrier, in which the background, in particular the concealment background (2A, 2B, 2C) of the carrier, is produced by way of printing techniques which are accessible for the mass production of printed products, and the confidential data is applied by means of heat fixing printing methods, in particular laser printing methods. A mass production of printed products preferably takes place by way of offset printing, letterpress printing, gravure printing, flexographic printing or screen printing.

### LIST OF DESIGNATIONS

1 Substrate
2A Concealment background (hydrochromic and/or piezochromic)
2B Concealment background (non-chromogenic)
2C Concealment background comprising a transparent non-chromogenic printing ink which phosphoresces under UV light
3 Confidential data comprising a non-chromogenic printing ink
3A Confidential data comprising a transparent hydrochromic and/or piezochromic printing ink
4 Layer comprising a transparent hydrochromic and/or piezochromic printing ink

1-12. (canceled)

13. A carrier for applying confidential data, the carrier comprising:
a substrate; and
a background applied on said substrate, said background including an irregular configuration of characters, and said characters being formed of at least one of a heat-resistant hydrochromic or piezochromic printing ink changing its coloration irreversibly upon at least one of an external physical or chemical action.

14. The carrier according to claim 13, wherein said background is a concealment background.

15. A data carrier having applied confidential data, the data carrier comprising:
a carrier according to claim 13; and
confidential data applied on said background of said carrier;
said confidential data being formed of a non-chromogenic printing ink having a coloration being identical to a coloration of said background before at least one of an external physical or chemical action, and said coloration being different than a coloration of said background after said at least one of external physical or chemical action.

16. The carrier according to claim 14, wherein said concealment background is formed of an irregular configuration of characters and rastered elements in locations.

17. The carrier according to claim 15, wherein said non-chromogenic printing ink of said background has a black coloration.

18. The carrier according to claim 13, wherein said coloration of said at least one of heat-resistant hydrochromic or piezochromic printing ink of said background before the at least one of external physical or chemical action is black.

19. The carrier according to claim 13, wherein the at least one of external physical or chemical action is an action by way of at least one of moisture or pressure.

20. The data carrier according to claim 15, wherein the at least one of external physical or chemical action is an action by way of at least one of moisture or pressure.

21. The carrier according to claim 13, wherein said at least one of heat-resistant hydrochromic or piezochromic printing ink is a dispersion of liquid-filled microspheres in a matrix liquid.

22. The carrier according to claim 13, wherein said applied printing ink has a layer thickness of from 0.5 g/m² to 5 g/m².

23. The data carrier according to claim 15, wherein said applied printing ink has a layer thickness of from 0.5 g/m² to 5 g/m².

24. The carrier according to claim 14, wherein said concealment background is offset printed, letterpress printed, gravure printed, flexographic printed or screen printed, and said confidential data is heat-fixed printed, laser printed or inkjet printed.
